(19) United States
(12) Patent Application Publication
(10) Pub. No.: US 2018/0282979 A1
(43) Pub. Date: Oct. 4, 2018

(54) METHODS AND SYSTEMS FOR INHIBITING FREEZING OF PIPES

(71) Applicants: Michael MAGGIO, Cranford, NJ (US); David HENDRICKS, North Bergen, NJ (US)

(72) Inventors: Michael MAGGIO, Cranford, NJ (US); David HENDRICKS, North Bergen, NJ (US)

(73) Assignees: Michael MAGGIO, Cranford, NJ (US); David HENDRICKS, North Bergen, NJ (US)

(21) Appl. No.: 15/474,315

(22) Filed: Mar. 30, 2017

(51) Int. Cl. E03B 7/12; E03B 7/08; G05D 7/06

(52) U.S. Cl. CPC E03B 7/12; G05D 7/0635; E03B 7/08

(57) ABSTRACT

Methods of and systems for inhibiting freezing of a set of pipes are provided. One system includes: a first connector connected to a first fluid supply line; a second connector connected to a second fluid supply line; a valve fluidly connected to the first connector and the second connector; and a third connector connected to a drain line and fluidly connected to the valve. One method includes providing the above system and running fluid from the first and second fluid supply lines into a drain line when a temperature falls below a threshold or a flow rate falls below a threshold.

### FIELD OF THE INVENTION

The present invention relates to systems and methods of prohibiting pipes from freezing and more particularly, the use of connectors and valves connected to the pipes and a drain line.

### BACKGROUND

According to some studies, nearly a quarter of a million properties and corporations in the United States alone are affected by damage from a frozen pipe every year. This is five times greater than fire damage claims and second only to hurricanes by both the number of homes damaged and the cost of the claims. Repairs due to frozen pipes can cost $50,000 from flooding due to frozen water pipes breaking.

Current methods of reducing the chance of pipes freezing include introducing hot water into a closed plumbing system, for instance in front of the location of the frozen pipes, in an attempt to thaw the pipes enough to allow water flow. This is inefficient and can cause overflow and damage to surrounding systems due to the large amounts of water introduced to the closed system. Additionally, the hot water may never actually reach the frozen area, especially if there are numerous branches in the system. Other methods include permanent adapters attached to the pipes, which frequently require power, and thus must be connected to an energy source at all times. As with the other methods, the hot water may never reach a frozen area, and the ability to supply power may be interrupted.

Therefore, it may be desirable to develop methods and systems of reliably preventing the freezing of pipes more efficiently and effectively.

### BRIEF SUMMARY

The shortcomings of the prior art are overcome and additional advantages are provided through the provisions of, in one aspect, a system for inhibiting freezing of a set of pipes that includes, for instance: a first connector connected to a first fluid supply line; a second connector connected to a second fluid supply line; a valve, such as a solenoid valve, fluidly connected to the first connector and the second connector; and a third connector connected to a drain line and fluidly connected to the valve.

In another aspect, a method of inhibiting freezing of a set of pipes includes, for instance: providing a system, the system including: a first connector connected to a first fluid supply line; a second connector connected to a second fluid supply line; a valve fluidly connected to the first connector and the second connector; and a third connector connected to a drain line and fluidly connected to the valve; and running fluid from the first fluid supply line and the second fluid supply line into the drain line via the system when a local temperature falls below a threshold or a flow rate falls below a threshold.

### BRIEF DESCRIPTION OF THE SEVERAL VIEWS OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a schematic view of a system, in accordance with one or more aspects of the present invention; and

FIG. 2 depicts a schematic view of a system, in accordance with one or more aspects of the present invention.

### DETAILED DESCRIPTION

Aspects of the present invention and certain features, advantages, and details thereof, are explained more fully below with reference to the non-limiting embodiments illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating embodiments of the invention, are given by way of illustration only, and are not by way of limitation. Various substitutions, modifications, additions and/or arrangements within the spirit and/or scope of the underlying inventive concepts will be apparent to those skilled in the art from this disclosure. Note also that reference is made below to the drawings, which are not drawn to scale for ease of understanding, wherein the same reference numbers used throughout different figures designate the same or similar components.

Generally stated, disclosed herein are methods and systems of preventing a set of pipes from freezing. Advantageously, the methods allow for active prevention of frozen pipes efficiently and at various locations.

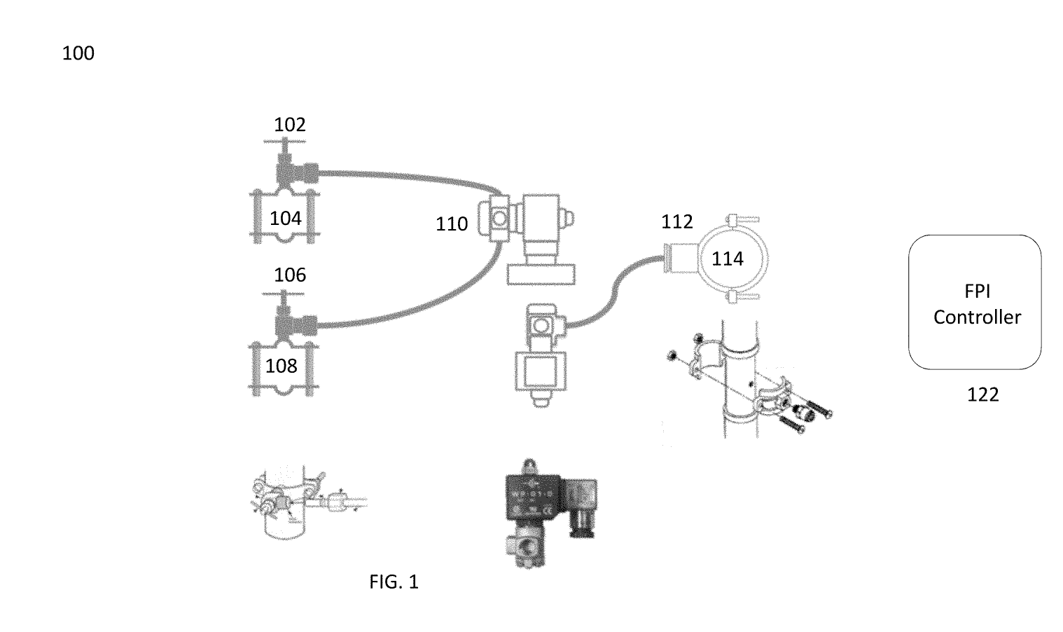

In one aspect, in one embodiment, as shown in FIG. 1, an example system 100 is illustrated. For instance, a first connector 102 may be connected, for instance fluidly, to a first fluid supply line 104. A second connector 106 may be connected, for instance fluidly, to a second fluid supply line 108. A valve, such as a solenoid valve 110 or other similar valve such as, but not limited to, direct acting valves, pilot-operated valves, two-way valves, three-way valves, four-way valves, globe valves, stop valves, check valves, ball valves, or butterfly valves, which may be fluidly connected to one or both of the first connector 102 and the second connector 106, may be provided. A third connector 112 may be connected, for instance fluidly, to a drain line 114, and fluidly connected to the solenoid valve 110. The first, second, and third connectors 102, 106, and 112, may include any connectors which may be attached to supply lines or drains of any now known or later construct, and may include, but are not limited to, a T-valve and a saddle valve. Advantageously, in some embodiments, connectors 102, 106, and 112 may be fitted simply by tightening a ring around a pipe or other supply or drain line, and turned until the pipe is punctured and a fluid connection is obtained, thereby allowing for a flow through the connector to the solenoid valve 110 or from the solenoid valve 110 to a drain line 114. These connectors can include a mechanism to turn on or off the flow of fluid.

The supply lines 104 and 108 can include, in some embodiments, water supply lines of any size, and in some embodiments may include one hot water supply and one cold water supply, for instance at a water pump or under a sink within a home or business. However, as should be clear to one of skill in the art, the supply lines can include water or beverage supply lines, as well as lines to a water heater or boiler system which may not be in constant use. The drain line 114 can include any drain, in particular a drain which may remove fluid from a home or business to a city drain line or a septic tank, or similar.

In some embodiments, the solenoid valve 110 may include, for instance, a three-way solenoid valve, as depicted in FIG. 1. In these embodiments, the first connector 102 and second connector 106 may be directly connected to the solenoid valve 110, which can be directly connected to the third connector 112 for direct connections utilizing only fluid lines therebetween, for instance plastic tubing.

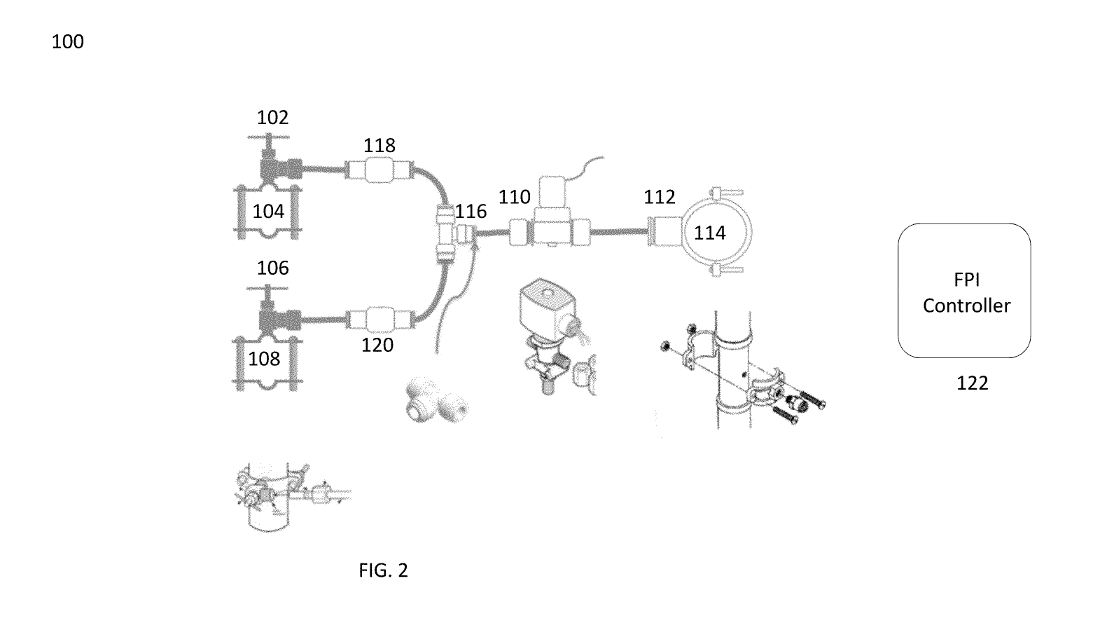

In a further embodiment, the solenoid valve 110 may be only a two-way valve. In these embodiments, as seen in FIG. 2, a T-valve 116 may be included between the solenoid valve 110 and the first connector 102 and the second connector 106. For some applications, one-way valves may be utilized to reduce the possibility of back feeding. For instance, a first one-way valve 118 may be used between the first connector 102 and the T-valve 116, and a second one-way valve 120 between the second connector 106 and the T-valve 116. This is for illustration purposes only, as further one-way valves could be utilized anywhere necessary, including but not limited to between the T-valve 116 and the solenoid valve 110, or between the solenoid valve 110 and the third connector 112, or in the system illustrated in FIG. 1. Any number of one-way valves may be utilized and any similar system configuration is intended to be included in the scope of this disclosure.

As illustrated in FIGS. 1 and 2, a controller 122, such as a frozen pipe inhibitor (FPI) controller, may be included with any system disclosed herein. For instance, the controller 122 may be electrically connected to or wirelessly in communication with the solenoid valve 110. The controller 122 may be manually operated or programmable. For instance, a wireless controller may be utilized which can open flow from one or both of the first and second connectors 102 and 106, allowing fluid to run from the first and second fluid supply lines 104 and 108 to the third connector 112, causing the fluid to drain out of drain line 114 and inhibit freezing by keeping a water flow when a local temperature is below a certain threshold, which can include any temperature at which a particular fluid is expected to freeze. The controller 122 can, for instance, be controlled from a wireless device, such as a mobile phone, tablet, or computer in wireless communication with a network or directly to the controller 122. Programs can be set periodically, daily, seasonally, or by any other methods. The controller 122 may be able to be controlled using software or applications designed for remote control of a home or business, such as any smart home technology now existing or later created.

Some embodiments may include a probe (not pictured) which can be a temperature probe, such as a digital or analog thermometer, in communication with the controller 122. Such a probe, or a plurality of probes, can be included on or near the controller 122, in or on the fluid supply lines, near the lines, anywhere the fluid may originate, or in, on or near the drain line 114, in order to determine, for example, an ambient temperature in or around the system 100. The controller 122 may use the data from the probe to determine operation of the solenoid valve 110. The probe may also, or alternatively, determine a flow rate, and can operate to open flow up when a flow rate falls below a certain threshold, which may be indicative of pipes beginning to freeze.

Accordingly, a method according to some embodiments, includes providing a system as described above. When pipes are likely to freeze, or before the possibility of freezing, the solenoid valve 110, by use of manual means or by communication with the controller 122, either manually or according to a program or input from a probe, at any of the above disclosed locations, may be turned on when a temperature as determined falls below a threshold or a flow rate falls below a threshold, which may include any temperature or flow rate as set by the program, a user, or periodically regardless of temperature, allowing the fluid from one or both of the first fluid supply line 102 and the second fluid supply line 106 to flow, with any overflow being directed to the third connector 112 and thus to the drain line 114. This movement of fluid may prevent freezing within any fluid lines up or downstream of the system 100 by virtue of the flow. The flow can be set to anywhere from 1% to 100% of the available flow at maximum opening of the lines, and can be run periodically, such as for one minute up to about ten minutes, for instance every five, 10, or fifteen minutes, or continuously until the temperature reaches above the threshold. These examples are only illustrative and not meant to be limiting. Such a method may be used in home and commercial water lines, as well as with any fluid moving pipes or lines, including but not limited to water, beverages, boilers, water heaters, wells, and indoor or outdoor water supply systems, such as pool pumps and viewing ponds.

In one example, the controller 122 may be set to turn the solenoid valve 110 on, causing fluid to flow from the first and second connectors 102 and 106, removing any overflow to drain valve 114 via the third connector 112, whenever a temperature, in some instances as determined by the probe, falls below, for example, 40 degrees Fahrenheit, below 34 degrees Fahrenheit, or below another predetermined temperature. The solenoid valve 110 can remain on until a temperature reaches or exceeds 40 degrees Fahrenheit, or 34 degrees Fahrenheit, continuously running the fluid to prevent freezing.

In another example, the solenoid valve 110 can, rather than running continuously, run, for example, for between 1 and 15 minutes, or between 10 and 15 minutes, every hour, or every two hours, or any other predetermined interval of time, whenever the temperature is below, for example, 40 degrees Fahrenheit, 34 degrees Fahrenheit, or another predetermined temperature. The solenoid valve 110 turns off when the temperature is above the threshold and stops the flow of fluid.

In another example, regardless of temperature, the solenoid valve 110 can turn on, causing fluid to flow, for example, for between 1 and 15 minutes, or between 10 and 15 minutes, every hour, or every two hours, or any other predetermined interval of time. In this example, the solenoid valve 110 may operate on a strictly seasonal basis, for instance during the winter months, or all year round.

Thus, a reliable system and method of preventing freezing pipes is provided which is active and efficient, easily installed, and may be readily monitored, for example, in conjunction with any smart home or similar technology which is now existing or may be later developed.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A system for inhibiting freezing of a set of pipes, the system comprising:
a first connector connected to a first fluid supply line;
a second connector connected to a second fluid supply line;
a valve fluidly connected to the first connector and the second connector; and
a third connector connected to a drain line and fluidly connected to the valve.

2. The system of claim 1, wherein at least one of the first connector, the second connector, and the third connector comprise a T-valve or a saddle valve.

3. The system of claim 1, further comprising:
a T-valve between both the first and second connector and the valve.

4. The system of claim 3, further comprising:
a first one way valve between the first connector and the T-valve; and
a second one way valve between the second connector and the T-valve.

5. The system of claim 1, wherein the valve comprises a three-way solenoid valve.

6. The system of claim 5, wherein the first connector and the second connector fluidly connect directly to the three-way solenoid valve.

7. The system of claim 1, further comprising:
a controller that wirelessly communicates with the valve.

8. The system of claim 7, wherein the controller is manually operated.

9. The system of claim 7, wherein the controller is programmable.

10. The system of claim 9, further including:
at least one probe, wherein the controller communicates with the probe and adjusts a flow from the first fluid supply line and the second fluid supply line based on the probe.

11. A method of inhibiting freezing of a set of pipes, the method comprising:
providing a system, the system including:
a first connector connected to a first fluid supply line;
a second connector connected to a second fluid supply line;
a valve fluidly connected to the first connector and the second connector; and
a third connector connected to a drain line and fluidly connected to the valve; and
running fluid from the first fluid supply line and the second fluid supply line into the drain line via the system when a local temperature falls below a threshold or when a flow rate falls below a threshold.

12. The method of claim 11, wherein at least one of the first connector, the second connector, and the third connector comprise a T-valve or a saddle valve.

13. The method of claim 11, further comprising:
a T-valve between both the first and second connector and the valve.

14. The method of claim 13, further comprising:
a first one way valve between the first connector and the T-valve; and
a second one way valve between the second connector and the T-valve.

15. The method of claim 11, wherein the valve comprises a three-way solenoid valve.

16. The method of claim 15, wherein the first connector and the second connector fluidly connect directly to the three-way solenoid valve.

17. The method of claim 11, further comprising:
a controller that wirelessly communicates with the valve.

18. The method of claim 17, wherein the controller is manually operated.

19. The method of claim 17, wherein the controller is programmable.

20. The method of claim 19, the system further including:
at least one probe, wherein the controller communicates with the probe and adjusts a flow of the fluid running based on the probe.
